(19) United States
(12) Patent Application Publication
(10) Pub. No.: US 2018/0114979 A1
(43) Pub. Date: Apr. 26, 2018

(54) Active Material Composite Particle, Electrode Composite Comprising the Same, Fabrication Method Thereof and All-Solid Battery

(71) Applicants: Hyundai Motor Company, Seoul (KR); IUCF-HYU (Industry-University Cooperation Foundation Hanyang University), Seoul (KR)

(72) Inventors: Yong Sub Yoon, Seoul (KR); Hong Seok Min, Yongin-si (KR); Kyung Su Kim, Yongin-si (KR); Oh Min Kwon, Busan (KR); Dong Wook Shin, Seongnam-si (KR); Chan Hwi Park, Seoul (KR); Seung Hyeon Son, Busan (KR)

(21) Appl. No.: 15/377,971

(22) Filed: Dec. 13, 2016

(30) Foreign Application Priority Data
Oct. 20, 2016 (KR) 10-2016-0136588

(51) Int. Cl. H01M 4/36; H01M 4/62; H01M 10/0525; H01M 4/04; H01M 10/0585

(52) U.S. Cl. CPC H01M 4/366; H01M 4/622; H01M 10/0585; H01M 4/0433; H01M 4/62; H01M 10/0525

(57) ABSTRACT

An active material composite particle serves as an active material for an electrode of an all-solid battery. The active material composite particle includes a bare electrode active material, and a fine-grained solid electrolyte, bound to a surface of the bare electrode active material via a solid binder. Other embodiments are also disclosed.

### CROSS-REFERENCE TO RELATED APPLICATIONS

The present application claims priority to Korean Patent Application No. 10-2016-0136588, filed Oct. 20, 2016, the entire contents of which is incorporated herein for all purposes by this reference.

### TECHNICAL FIELD

The present disclosure relates to an active material composite particle composed of an active material and a solid electrolyte with a stable interface formed therebetween, an electrode composite comprising the same, a fabrication method thereof, and an all-solid battery comprising the same.

### BACKGROUND

Finding applications as a power source for a variety of electronic appliances and machines including mobile phones, laptop computers, home appliances, automobiles, large-scale battery energy storage systems, etc., demand for lithium secondary batteries has sharply increased, and higher performance thereof is required. Active research is ongoing to meet this requirement.

Most currently used electrolytes for lithium secondary batteries are of an organic-matter-containing liquid type. However, such liquid electrolytes, although advantageous in terms of ion conductance, are in need of improved safety because of the high risk of fire and explosions at high temperatures.

One solution to the safety problem is a solid electrolyte.

A large contact area between a solid electrolyte and an electrode active material is necessary for the facilitation of lithium ion transport therebetween. To date, most all-solid batteries are fabricated using a uniaxial pressure-molding method in which contact is made between an electrode active material and a solid electrode by pressurization. However, because a solid electrolyte, unlike a liquid electrolyte, is hard, i.e. has morphological stability, there is a limit to the extent to which the contact area can be increased by simple pressurization.

FIGS. 1a and 1b are schematic views of the structures of conventional electrode composites. As shown, an electrode active material 1 is admixed with a solid electrolyte 2a or 2b and the admixture is pressure-molded into an electrode composite. Because the electrode composite of FIG. 1a comprises solid electrolyte 2a with a large particle size, the contact area between the electrode active material 1 and the solid electrolyte 2a is insufficient to allow the performance of the battery to be maximized.

This problem can be overcome by the employment of a solid electrolyte 2b having large particle sizes, which results in increased contact area between the electrode active material 1 and the solid electrolyte 2b. However, the fine-grained solid electrolyte 2b suffers from the disadvantage of being broken or delaminated when the volume of the electrode active material expands.

Hence, research into a variety of ends, including the reduction of particle sizes of electrode active materials, the use of two different particle sizes of electrode active materials, and the formation of a functional coat on an electrode active material has recently been conducted in order to improve the properties of electrode composites.

### SUMMARY

The present disclosure addresses an active material composite particle composed of an active material and a solid electrolyte, with a stable interface formed therebetween, an electrode composite comprising the same, a fabrication method thereof, and an all-solid battery comprising the same.

According to an aspect thereof, the present disclosure provides an active material composite particle, serving as an active material for an electrode of an all-solid battery, comprising a bare electrode active material and a fine-grained solid electrolyte bound to the surface of the bare electrode active material via a solid binder.

In one embodiment, the bare electrode active material has a particle size of 3 30 μm, the fine-grained solid electrolyte has a particle size of 1 μm or less, and the solid binder has a particle size of 10 n˜1 μm, with the proviso that the particle size of the solid binder is the same as or smaller than that of the fine-grained solid electrolyte.

In another embodiment, the solid binder, the bare electrode active material, and the fine-grained solid electrolyte are in point contact with one another.

In another embodiment, the solid binder is of a cross-linked structure.

In another embodiment, the fine-grained solid electrolyte contains lithium (Li), phosphorus (P), and sulfur (S).

According to another aspect thereof, the present disclosure provides a method for preparing an electrode active material for use in an all-solid battery. In a first preparation step, a bare electrode active material, a fine-grained solid electrolyte, and a solid binder are prepared. In a first mixing step, the bare electrode active material and the fine-grained solid electrolyte are mixed together by ball milling. In a binding step, a solid binder is added to the mixture of the bare electrode active material and the fine-grained solid electrolyte and mixed by ball milling to bind the fine-grained solid electrolyte to the bare electrode active material via the solid binder.

In one embodiment, the bare electrode active material, the fine-grained solid electrolyte, and the solid binder of the first preparation step have a particle size of 3˜30 m, 1 μm or less, and 10 nm˜1 μm, respectively.

In another embodiment, the bare electrode active material is mixed at a weight ratio of 80:5˜10 with the fine-grained solid electrolyte in the first mixing step.

In another embodiment, the solid binder is added at a weight ratio of bare electrode active material:solid binder 80:1 in the binding step.

In another embodiment, the ball milling is conducted at a speed of 200 rpm or less for 2 min or less in each of the first mixing step and the binding step.

According to a further aspect thereof, the present disclosure provides an electrode composite for use in an all-solid battery, comprising an active material composite particle in which a fine-grained solid electrolyte is attached to the surface of a bare electrode active material via a solid binder.

In one embodiment, the electrode composite further comprises a conductive material, along with a coarse-grained solid electrolyte having a larger particle size than the fine-grained solid electrolyte.

In another embodiment, the bare electrode active material has a particle size of 3˜30 μm, the fine-grained solid electrolyte has a particle size of 1 μm or less, the solid binder has a particle size of 10 nm˜1 μm, and the coarse-grained solid electrolyte has a particle size of 1˜100 μm (1 μm exclusive).

According to still another aspect thereof, the present disclosure provides a method for fabricating an electrode composite for use in an all-solid battery. In a first step, an active material composite particle based on a bare electrode active material is prepared and a fine-grained solid electrolyte is attached thereto via a solid binder. In a second step, the active material composite particle is mixed with the coarse-grained solid electrolyte, the conductive material, and the binder, and the mixture is pressure-molded into the electrode composite.

In one embodiment, the second step comprises a second preparation substep, in which a coarse-grained solid electrolyte having a larger particle size than the fine-grained solid electrolyte, a conductive material, and a binder are prepared; a second mixing substep, in which the active material composite particle, the conductive material, and the binder are mixed together; and a molding substep in which the mixture of the active material composite particle, the conductive material, and the binder is pressure-molded into the electrode composite.

According to another embodiment, in the second mixing substep, the coarse-grained solid electrolyte is used in an amount such that the bare electrode active material is present at a weight ratio of 80:20 with the total of the fine-grained solid electrolyte and the coarse-grained solid electrolyte, and an amount of the conductive material is controlled so that the weight ratio of the bare electrode active material to the conductive material is 80:2.

According to a still further aspect thereof, the present disclosure provides an all-solid battery, comprising: an anode composite unit including an anode active material composite particle based on a bare anode active material to which a fine-grained solid electrolyte is attached via a solid binder; a cathode composite unit including a cathode active material composite particle based on a bare cathode active material to which a fine-grained solid electrolyte is attached via a solid binder; and a solid electrolyte unit in which a solid electrolyte is filled between the anode composite unit and the cathode composite unit.

In an embodiment, each of the anode composite unit and the cathode composite unit further comprises a coarse-grained solid electrolyte, having a larger particle size than the fine-grained solid electrolyte, along with a conductive material.

In another embodiment, the anode bare electrode active material for the anode composite unit and the cathode bare electrode active material for the cathode composite each have a particle size of 3˜30 μm, the fine-grained solid electrolyte has a particle size of 1 μm or less, the solid binder has a particle size of 10 nm˜1 μm, and the coarse-grained solid electrolyte has a particle size of 1˜100 μm (1 μm exclusive).

In another embodiment, the fine-grained solid electrolyte and the coarse-grained solid electrolyte of the anode composite unit and the cathode composite unit are prepared from a material identical to that of the solid electrolyte of the solid electrolyte unit.

### BRIEF DESCRIPTION OF THE DRAWINGS

The above and other objects, features and other advantages of the present invention will be more clearly understood from the following detailed description when taken in conjunction with the accompanying drawings, in which:

FIGS. 1a and 1b are schematic views of the structures of conventional electrode composites;

FIG. 2 is a schematic view of the structure of an electrode composite including active material composite particles in accordance with an embodiment of the present disclosure;

FIG. 3 is a flow diagram showing a method for the fabrication of an electrode composite comprising an active material composite particle in accordance with an embodiment of the present disclosure; and

FIG. 4 is a schematic view of the structure of an all-solid battery comprising the active material composite particles in accordance with some embodiments of the present disclosure.

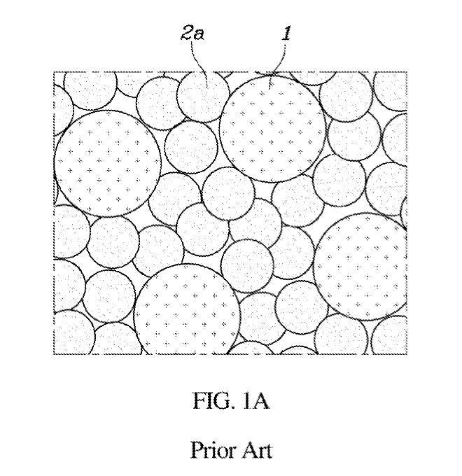

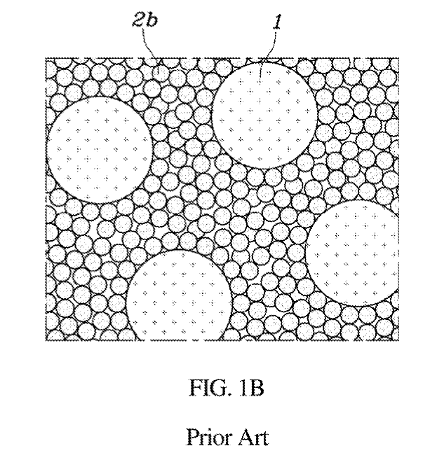

### DETAILED DESCRIPTION OF ILLUSTRATIVE EMBODIMENTS

Terminologies stated herein are used only for describing specific embodiments without limiting the present invention. The singular terms used herein include plural terms unless phrases express opposite meanings clearly. The term ‘including’ used herein indicates concrete specific characteristics, regions, positive numbers, steps, operations, elements and/or components, without limiting the existence or addition of other specific characteristics, regions, positive numbers, steps, operations, elements and/or components.

If not differently defined, all the terms, including technical terms and scientific terms used hereafter, have the same meanings as those that those skilled in the art generally understand. The terms defined in dictionaries should be construed as having meanings corresponding to the related prior art documents and those stated herein and not construed as being ideal or official, if not defined.

Hereinafter, the present disclosure is described in greater detail with reference to the accompanying drawings.

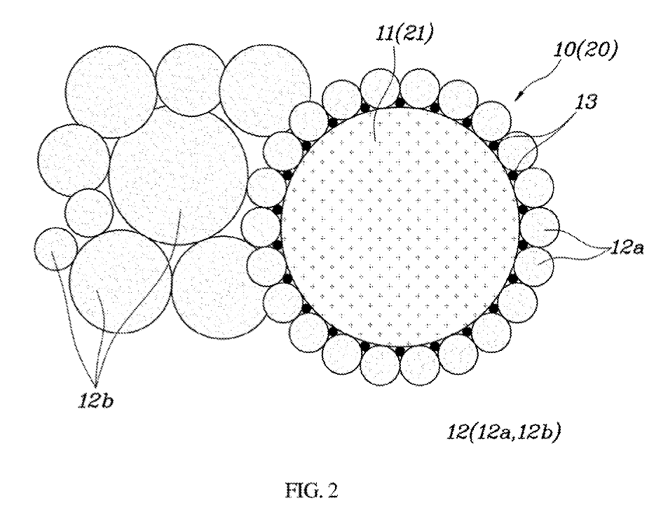

FIG. 2 is a schematic view of the structure of an electrode composite including active material composite particles in accordance with an embodiment of the present disclosure.

The present disclosure addresses an active material composite particle, an electrode composite comprising the same, and an all-solid battery comprising the same. First, a description will be given of the active material composite particle.

As shown in FIG. 2, the active material composite particle 10 or 20 according to an embodiment of the present disclosure comprises a bare electrode active material 11 or 21 and a fine-grained solid electrolyte 12a, bound via a solid binder 13 to the surface of the bare electrode active material 11 or 21.

The bare electrode active material 11 or 21 may be an anode active material or a cathode active material. As the bare anode active material 11, LCO, NCM, or LFP may be used, while examples of the bare cathode active material 21 include natural graphite, synthetic graphite, carbons, Si, and Sn. Various materials may be used without limitations imposed thereto, so long as they can serve as an anode or cathode active material.

The fine-grained solid electrolyte 12a is a solid electrolyte containing lithium (Li), phosphorus (P) and sulfur (S) therein.

The solid binder 13 functions to attach the fine-grained solid electrolyte 12a to the surface of the bare electrode active material 11 or 21, and particularly has a cross-linked structure. For example, polytetrafluoroethylene (PTFE) may be used as the solid binder. Various solid binders may be employed without limitation as long as they can attach the fine-grained solid electrolyte 12a to the bare electrode active material 11 or 21.

Meanwhile, the solid binder 13, the bare electrode active material 11 or 21, and the fine-grained solid electrolyte 12a are in point contact with one another. Particularly, the solid binder 13 serves to attach the fine-grained solid electrolyte 12a to the bare electrode active material 11 or 21 therethrough.

In order for the contact area among the bare electrode active material 11 or 21, the fine-grained solid electrolyte 12a, and the solid binder 13 to be maximized upon binding while they all maintain interface contact therebetween, limitations are preferably imposed on the particle sizes thereof. For example, the particle size may be limited to 3˜30 m for the bare electrode active material 11 or 21, to 1 μm or less for the fine-grained solid electrolyte 12a, and to 10 nm˜1 μm for the solid binder 13.

Compared to the bare electrode active material 11 or 21, the fine-grained solid electrolyte 12a and the solid binder 13 are smaller in particle size. Particularly, the particle size of the solid binder 13 is as small as or smaller than that of the fine-grained solid electrolyte 12a, so that the solid binder 13 readily mediates the binding of the fine-grained solid electrolyte 12a to the bare electrode active material 11 or 21.

Meanwhile, the electrode composite comprising the active material composite particle 10 or 20 is explained.

The electrode composite comprises the active material composite particle 10 or 20 in which the fine-grained solid electrolyte 12a is bound to the surface of the bare electrode active material 11 or 21 via the solid binder 13, plus a coarse-grained solid electrolyte 12b, which is larger in grain size than the fine-grained solid electrolyte 12a.

The active material composite particle 10 or 20 is as described above.

In some embodiments, the coarse-grained solid electrolyte 12b is identical in material to the fine-grained solid electrolyte 12a. That is, the only difference between the coarse-grained solid electrolyte 12b and the fine-grained solid electrolyte 12a is the particle size.

For example, the fine-grained solid electrolyte 12a, which is a constituent of the active material composite particle 10 or 20, may have a particle size of 1 μm or less, while the coarse-grained solid electrolyte 12b may have a particle size between 1 and 100 μm (1 μm exclusive). In addition, other constituents of the active material composite particle 10 or 20, that is, the bare electrode active material 11 or 21 and the solid binder 13, may range in particle size from 3 to 30 μm and from 10 nm to 1 μm, respectively.

As for the relative amount of the coarse-grained solid electrolyte 12b, the bare electrode active material 11 or 21 may be mixed at a weight ratio of 80:20 with the combination of the fine-grained solid electrolyte 12a and the coarse-grained solid electrolyte 12b.

In some embodiments, the electrode composite may further comprise a conductive material (not shown). In an all-solid battery, the reaction between electrode materials needs both electrons and lithium ions. The fine-grained solid electrolyte 12a and the coarse-grained solid electrolyte 12b, which are admixed in the electrode composite, can transport lithium ions, but cannot carry electrons because both of them lack electron conductivity. Accordingly, a conductive material is used to carry electrons.

According to a particular embodiment, the weight ratio of the bare electrode active material 11 or 21 to the conductive material is 80:2.

As the conductive material, nano-size conductive particles such as carbon black, Ketjen black, etc., conductive carbon materials such as CNT, VGCF, etc., or a metal material inert to sulfides, such as Ni, may be used.

Also, the electrode composite may further comprise a binder (not shown) that acts to enhance adhesion among the active material composite particle 10 or 20, the conductive material, and the coarse-grained solid electrolyte 12b. In this regard, the binder may be the same as the solid binder 13. The binder is not limited to the materials exemplified above. So long as they enhance adhesion among the active material composite particle 10 or 20, the binder, and the coarse-grained solid electrolyte 12b, various binders may be employed.

In a particular embodiment, therefore, the electrode composite may be fabricated by pressure-molding a mixture of the active material composite particle 10 or 20, the coarse-grained solid electrolyte 12b, the conductive material, and the binder.

Below, a method for fabricating the electrode composite comprising the active material composite particle is explained.

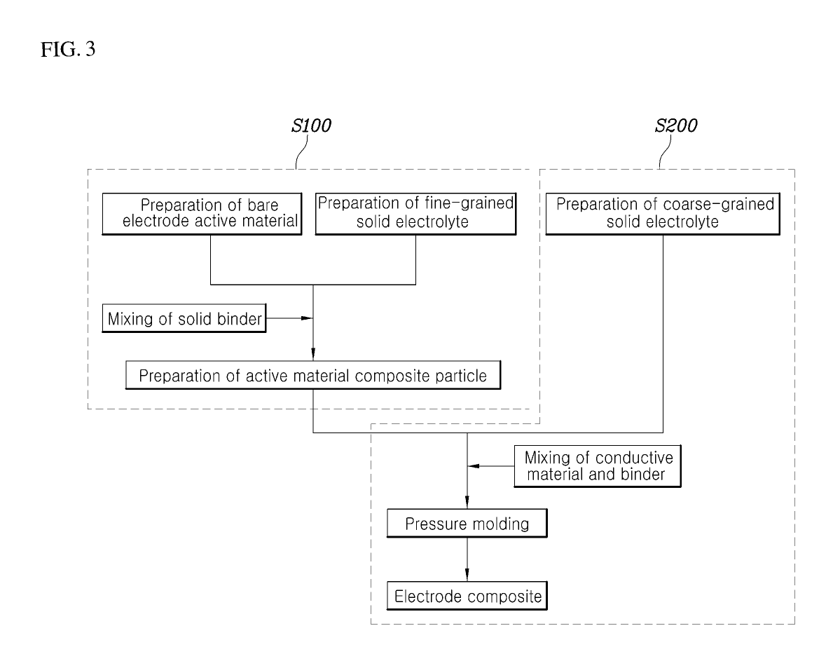

FIG. 3 is a flow diagram showing a method for the fabrication of an electrode composite comprising an active material composite particle in accordance with an embodiment of the present disclosure.

As shown in FIG. 3, the method for fabricating an electrode composite comprises a first step of preparing an active material composite particle 10 or 20 (S100) and a second step of using the active material composite particle 10 or 20 to acquire the electrode composite (S200).

In the first step (S100), an active material composite particle 10 or 20 composed of a bare electrode active material 11 or 21 to which a fine-grained solid electrolyte 12a is attached via a solid binder 13 is prepared.

In detail, the first step of preparing the active material composite particle 10 or 20 (S100) comprises: a first preparation substep, in which a bare electrode active material 11 or 21, a fine-grained solid electrolyte 12a and a solid binder 13 are prepared; a first mixing substep, in which the bare electrode active material 11 or 21 and the fine-grained solid electrolyte 12a are mixed together through ball milling; a binding substep, in which a solid binder 13 is added to the mixture of the bare electrode active material 11 or 21 and the fine-grained solid electrolyte 12a and ball-milled to bind the fine-grained solid electrolyte 12a to the bare electrode active material 11 or 21 via the solid binder 13.

In the first preparation substep, the bare electrode active material 11 or 21, the fine-grained solid electrolyte 12a, and the solid binder 13 are prepared separately.

As for the bare electrode active materials 11 and 21, a bare anode active material 11 and a bare cathode active material 21 are prepared separately. Thus, the anode and the cathode active material composite particles 10 and 20 are prepared separately.

For the bare anode active material 11, LCO, NCM, and/or LFP is used, while the bare cathode active material 21 is based on natural graphite, artificial graphite, carbons, Si, and/or Sn. The bare electrode active materials 11 and 21 may range in particle size from 3 to 30 μm.

The fine-grained solid electrolyte 12a may contain lithium (Li), phosphorus (P), and sulfur (S), and may have a particle size of 1 μm or less.

The fine-grained solid electrolyte 12a may be prepared in any of various manners. For instance, its preparation may be achieved according to the following fine-grained solid electrolyte preparation protocol:

<Protocol for Preparation of Fine-Grained Solid Electrolyte>

1) Commercially available P₂S₅ is weighed at a molar ratio of 30:70 relative to 2 g of commercially available Li₂S, and they are mixed, together with 10 ml of toluene and 10 g of zirconia balls having a diameter of 3 mm, at 120 rpm for 24 hrs in a 20-ml glass jar.

2) The zirconia balls are filtered out from the resulting suspension which is then fed, together with an additional 90 ml of the solvent, into a high-temperature/high-pressure reactor.

3) The temperature of the reactor is elevated to 140° C. and maintained at that temperature for 24 hrs while the suspension is continuously stirred to prevent settling of the particles and to maintain a uniform dispersion.

4) After completion of the reaction, the resultant powder was filtered and dried for 2 hrs at a temperature 10° C. higher than the boiling point of the solvent.

5) The dried powder is crystallized at 300° C. for 3 hrs to afford sulfide-based crystals.

6) As a result, a fine-grained solid electrolyte having a particle size of 1 μm or less is produced.

For the solider binder 13, polytetrafluoroethylene (PTFE) particles ranging in size from 10 nm to 1 μm are prepared.

The first mixing substep is set to mix the prepared materials, that is, the bare electrode active material 11 or 21 and the fine-grained solid electrolyte 12a, through ball milling. In this regard, the bare electrode active material 11 or 21 is particularly mixed at a weight ratio of 80:5˜10 with the fine-grained solid electrolyte 12a. The reason why a limitation is imposed on the weight ratio between the bare electrode active material 11 or 21 and the fine-grained solid electrolyte 12a is that when the fine-grained solid electrolyte 12a is attached to the surface of the bare electrode active material 11 or 21, the maximum contact area therebetween can be achieved at this weight ratio, in consideration of their particle sizes.

Using a planetary ball mill (P5, Fritch), the mixing of the bare electrode active material 11 or 21 and the fine-grained solid electrolyte 12a may be conducted at 200 rpm or less for 2 min or less.

After the bare electrode active material 11 or 21 is homogeneously mixed with the fine-grained solid electrolyte 12a, a binding substep is performed.

The binding substep is a process in which the mixture of the bare electrode active material 11 and 21 and the fine-grained solid electrolyte 12a is ball-milled, together with the solid binder 13, to bind the fine-grained solid electrolyte 12a to the surface of the bare electrode active material 11 and 21 via the solid binder 13.

Like the first mixing substep, the binding substep utilizes a planetary ball mill. The solid binder 13 is added to the mixture of the bare electrode active material 11 or 21 and the fine-grained solid electrolyte 12a prepared in the first mixing substep, followed by ball milling at 200 rpm or less for 2 min or less.

The reason why the maximum speed and time of ball milling are limited in the first mixing substep and the binding substep is that the ball milling conducted at a higher speed or for a longer time may break the bare electrode active material 11 or 21 and the fine-grained solid electrolyte 12a.

In the binding substep, the solid binder 13 is added at a weight ratio of 80:1 (bare electrode active material:solid binder). The reason why a limitation is imposed on the weight ratio between the bare electrode active material 11 or 21 and the solid binder 13 is that, when the fine-grained solid electrolyte 12a is attached to the surface of the bare electrode active material 11 or 21 in consideration of their particle sizes, the maximum contact area therebetween can be achieved at that weight ratio, with interfacial contact therebetween stabilized through the solid binder 13.

During the ball milling at the maximum speed for the maximum time, the bare electrode active material 11 or 21 is physically studded with the fine-grained solid electrolyte 12a via the solid binder 13.

As described above, the bare electrode active material 11 or 21, the fine-grained solid electrolyte 12a, and the solid binder 13 are ball-milled to prepare the active material composite particle 10 or 20.

Next, in the second step (S200), a coarse-grained solid electrolyte 12b, a conductive material and a binder are mixed with the active material composite particle 10 or 20 prepared in the first step (S100), and the mixture is molded at a predetermined pressure into the electrode composite.

The second step (S200) includes a second preparation substep in which a coarse-grained solid electrolyte 12b having a larger particle size than the fine-grained solid electrolyte 12a, a conductive material, and a binder are prepared; a second mixing substep in which the active material composite particle 10 or 20, the conductive material, and the binder are mixed together; and a molding substep in which the mixture of the active material composite particle 10 or 20, the conductive material, and the binder is pressure-molded into an electrode composite.

The second preparation substep is set to prepare the coarse-grained solid electrolyte 12b, the conductive material, and the binder.

The coarse-grained solid electrolyte 12b may be prepared in various manners. For instance, its preparation may be achieved according to the following coarse-grained solid electrolyte preparation protocol:

<Protocol for Preparation of Coarse-Grained Solid Electrolyte>

(a) A solid electrolyte material containing Li₂S and P₂S₅ at a molar ratio of 75% to 25% is prepared.

(b) Using a planetary ball mill (P7, Fritch), the solid electrolyte material is ball-milled at 600 rpm for 24 hrs.

(c) The ball-milled solid electrolyte is thermally treated at 280° C. for 3 hrs.

(d) As a result, a coarse-grained solid electrolyte having a particle size of 1˜100 μm (1 μm exclusive) is obtained.

As the conductive material, nano-size conductive particles such as carbon black, Ketjen black, etc., conductive carbon materials such as CNT, VGCF, etc., or a metal material inert to sulfides, such as Ni, may be used.

The binder may the same as the solid binder 13, or may be any one that is typically used in all-solid batteries.

The second mixing substep is set to subject the active material composite particle 10 or 20, the coarse-grained solid electrolyte 12b, the conductive material, and the binder to a ball milling process.

In the second mixing substep, the coarse-grained solid electrolyte 12b is used in an amount such that the bare electrode active material 11 or 21 is present at a weight ratio of 80:20 with a sum of the fine-grained solid electrolyte 12a and the coarse-grained solid electrolyte 12b. The amount of conductive material is controlled so that the weight ratio of the bare electrode active material 11 or 21 to the conductive material is 80:2. The reason for limiting the amounts of the coarse-grained solid electrolyte and the conductive material is to achieve maximal efficiency in the all-solid battery.

After the active material composite particle 10 or 20, the coarse-grained solid electrolyte 12b, the conductive material, and the binder are homogeneously mixed, the molding substep is conducted.

In the molding substep, the mixture of the active material composite particle 10 or 20, the coarse-grained solid electrolyte 12b, the conductive material, and the binder is molded into an electrode composite by uniaxial compression.

Through the molding process, the electrode composite is obtained.

From the anode and the cathode active material composite particles 10 and 20, anode and cathode composites are obtained, respectively.

Next, the description turns to an all-solid battery comprising both the anode and the cathode composites.

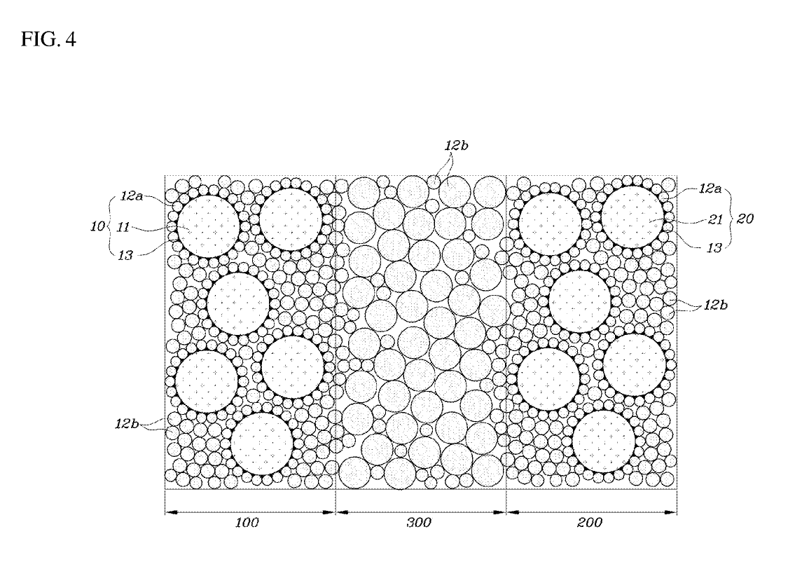

FIG. 4 is a schematic view of the structure of an all-solid battery comprising the active material composite particles in accordance with some embodiments of the present disclosure.

As can be seen in FIG. 4, the all-solid battery according to some embodiments of the present disclosure comprises an anode composite unit 100 including an anode active material composite particle 10 composed of a bare anode active material 11 to which fine-grained solid electrolyte 12a is attached via a solid binder 13; a cathode composite unit 200 including a cathode active material composite particle 20 composed of a bare cathode active material 21 to which a fine-grained solid electrolyte 12a is attached via a solid binder 13; and a solid electrolyte unit 300 in which a solid electrolyte is disposed between the anode composite unit 100 and the cathode composite unit 200.

The anode composite unit 100 consists of the anode composites, prepared from the bare anode active material 11 in the same manner as described above for the electrode composite.

Also, the cathode composite 200 consists of the cathode composites, prepared from the bare cathode active material 21 in the same manner as described above for the electrode composite.

The solid electrolyte unit 300 is an area containing solid electrolyte 12b comprising lithium (Li), phosphorus (P), and sulfur (S). In a particular embodiment, the fine-grained solid electrolyte 12a and the coarse-grained solid electrolyte 12b of the anode composite unit and the cathode composite unit are prepared from the same material as the solid electrolyte 12b of the solid electrolyte unit 300.

A better understanding of the present invention may be obtained through the following examples which are set forth to illustrate, but are not to be construed as limiting the present invention.

All-solid batteries were fabricated using the active material composite particles of the present disclosure, as shown in Table 1, and tested for battery performance.

The all-solid batteries according to Examples and Comparative Examples were subjected to a charge-discharge cycle test at a current density of C/10, and the test results are given in Table 1, below. In Table 1, the numbers given to the bare electrode active material, the fine-grained solid electrolyte, the coarse-grained solid electrolyte, the solid binder, and the conductive material are percentages by weight.

TABLE 1

| | Bare | Fine- | Coarse- | | | Initial |
|---|---|---|---|---|---|---|
| | Electrode | Grain | Grain | | | Discharge |
| | Active | Solid | Solid | Solid | Conductive | Capacity |
| | Material | Electrolyte | Electrolyte | Binder | Material | (mAh/g) |
| Ex. 1 | 80 | 10 | 10 | 1 | 2 | 117.84 |
| Ex. 2 | 80 | 5 | 15 | 1 | 2 | 127.49 |
| C. Ex. 1 | 80 | — | 20 | — | 2 | 90.93 |
| C. Ex. 2 | 70 | — | 30 | — | 2 | 112.32 |
| C. Ex. 3 | 80 | 20 | — | — | 2 | 103.64 |
| C. Ex. 4 | 80 | — | 20 | — | 2 | 92.36 |
| C. Ex. 5 | 90 | — | 10 | — | 2 | 64.37 |
| C. Ex. 6 | 80 | | 20 | — | 1 | 78.63 |

As understood from the data of Table 1, the initial discharge capacities of Examples 1 and 2 were improved compared to those of the Comparative Examples. These results are attributed to the fact that the attachment of the fine-grained solid electrolyte to the bare electrode active material via the solid binder increases the contact area between the fine-grained solid electrolyte and the bare electrode active material and maintains stable contact therebetween, thus enhancing the initial discharge capacity of the all-solid battery.

Particularly, the all-solid battery of Comparative Example 3 employed the fine-grained solid electrolyte, and was fabricated using a compression-molding process, without the solid binder. Its initial discharge capacity was found to be higher than those of the other Comparative Examples, but lower than those of Examples. These data indicate that although the contact area between the fine-grained solid electrolyte and the bare electrode active material was increased, stable contact therebetween was not maintained.

Structure to have a solid binder through which a fine-grained solid electrolyte is bound to a bare electrode active material, as described hitherto, the active material composite particle allows the solid electrolyte to maintain stable contact with the electrode active material without delamination even upon the cubical expansion of the electrode active material.

In addition, because the fine-grained solid electrolyte is brought into point contact with the solid binder by ball milling, the maximum contact area between the fine-grained solid electrolyte and the electrode active material can be achieved while interfacial contact is maintained therebetween.

Although exemplary embodiments of the present invention were described above with reference to the accompanying drawings, those skilled in the art will understand that the present invention may be implemented in various ways without changing the necessary features or the spirit of the prevent invention.

Therefore, it should be understood that the exemplary embodiments are not limiting but illustrative in all aspects. The scope of the present invention is defined not by the specification, but by the following claims, and all changes and modifications obtained from the meaning and range of claims and equivalent concepts should be construed as being included in the scope of the present invention.

What is claimed is:

1. An active material composite particle serving as an active material for an electrode of an all-solid battery, the active material composite particle comprising:
a bare electrode active material; and
a fine-grained solid electrolyte, bound to a surface of the bare electrode active material via a solid binder.

2. The active material composite particle of claim 1, wherein the bare electrode active material has a particle size of 3˜30 μm, the fine-grained solid electrolyte has a particle size of 1 μm or less, and the solid binder has a particle size of 10 n˜1 μm, wherein the particle size of the solid binder is identical to or smaller than the particle size of the fine-grained solid electrolyte.

3. The active material composite particle of claim 1, wherein the solid binder, the bare electrode active material, and the fine-grained solid electrolyte are in point contact with one another.

4. The active material composite particle of claim 3, wherein the solid binder has a cross-linked structure.

5. The active material composite particle of claim 3, wherein the fine-grained solid electrolyte contains lithium (Li), phosphorus (P), and sulfur (S).

6. A method for preparing an electrode active material for use in an all-solid battery, the method comprising:
preparing a bare electrode active material, a fine-grained solid electrolyte, and a solid binder;
mixing the bare electrode active material and the fine-grained solid electrolyte together by ball milling;
adding a solid binder to the mixture of the bare electrode active material and the fine-grained solid electrolyte; and
mixing the solid binder and the mixture of the bare electrode active material and the fine-grained solid electrolyte by ball milling to bind the fine-grained solid electrolyte to the bare electrode active material via the solid binder.

7. The method of claim 6, wherein the bare electrode active material has a particle size of 3˜30 μm, the fine-grained solid electrolyte has a particle size of 1 μm or less, and the solid binder has a particle size of 10 nm˜1 μm.

8. The method of claim 7, wherein mixing the bare electrode active material and the fine-grained solid electrolyte comprises mixing the bare electrode active material at a weight ratio of 80:5˜80:10 with the fine-grained solid electrolyte.

9. The method of claim 7, wherein, when mixing the solid binder and the mixture, the solid binder is added at a weight ratio of bare electrode active material:solid binder of 80:1.

10. The method of claim 6, wherein the ball milling is conducted at a speed of 200 rpm or less for 2 min or less when mixing the bare electrode active material and the fine-grained solid electrolyte; and
wherein the ball milling is conducted at a speed of 200 rpm or less for 2 min or less when mixing the solid binder and the mixture.

11. An electrode composite for use in an all-solid battery, the electrode composite comprising an active material composite particle in which a fine-grained solid electrolyte is attached to a surface of a bare electrode active material via a solid binder.

12. The electrode composite of claim 11, further comprising a conductive material and a coarse-grained solid electrolyte having a larger particle size than the fine-grained solid electrolyte.

13. The electrode composite of claim 12, wherein the bare electrode active material has a particle size of 3˜30 μm, the fine-grained solid electrolyte has a particle size of 1 μm or less, the solid binder has a particle size of 10 nm˜1 μm, and the coarse-grained solid electrolyte has a particle size of 1˜100 μm (exclusive of 1 μm).

14. A method for fabricating an electrode composite for use in an all-solid battery, the method comprising:
preparing an active material composite particle based on a bare electrode active material to which a fine-grained solid electrolyte is attached via a solid binder;
mixing the active material composite particle with a coarse-grained solid electrolyte, a conductive material, and the binder to form a mixture; and
pressure-molding the mixture into the electrode composite.

15. The method of claim 14, wherein the mixing step comprises preparing a coarse-grained solid electrolyte having a larger particle size than the fine-grained solid electrolyte, a conductive material, and a binder, and mixing the active material composite particle, the conductive material, and the binder together; and
wherein the pressure-molding step comprises pressure-molding the mixed active material composite particle, the conductive material, and the binder into the electrode composite.

16. The method of claim 15, wherein, when mixing the active material composite particle, the conductive material, and the binder, the coarse-grained solid electrolyte is used in an amount such that the bare electrode active material is present at a weight ratio of 80:20 with a sum of the fine-grained solid electrolyte and the coarse-grained solid electrolyte, and an amount of the conductive material is controlled so that a weight ratio of the bare electrode active material to the conductive material is 80:2.

17. An all-solid battery, comprising:
an anode composite unit including an anode active material composite particle based on a bare anode active material to which a fine-grained solid electrolyte is attached via a solid binder;
a cathode composite unit including a cathode active material composite particle based on a bare cathode active material to which a fine-grained solid electrolyte is attached via a solid binder; and
a solid electrolyte unit in which a solid electrolyte is filled between the anode composite unit and the cathode composite unit.

18. The all-solid battery of claim 17, wherein the anode composite unit and the cathode composite unit each further comprise a coarse-grained solid electrolyte, having a larger particle size than the fine-grained solid electrolyte, and a conductive material.

19. The all-solid battery of claim 18, wherein the bare anode active material for the anode composite unit and the bare cathode active material for the cathode composite each have a particle size of 3˜30 μm, the fine-grained solid electrolyte has a particle size of 1 μm or less, the solid binder has a particle size of 10 nm˜1 μm, and the coarse-grained solid electrolyte has a particle size of 1˜100 μm (1 μm exclusive).

20. The all-solid battery of claim 18, wherein the fine-grained solid electrolyte and the coarse-grained solid electrolyte of the anode composite unit and the cathode composite unit are prepared from a material identical to that of the solid electrolyte of the solid electrolyte unit.
